(19) United States
(12) Patent Application Publication
(10) Pub. No.: US 2012/0143781 A1
(43) Pub. Date: Jun. 7, 2012

(54) OPERATIONALIZING SERVICE METHODOLOGIES FOR A COMPUTERIZED CONSULTANT ENVIRONMENT

(75) Inventors: Elad Fein, Haifa (IL); Amit Fisher, Nofit (IL); Richard Thomas Goodwin, New York, NY (US); Pietro Mazzoleni, New York, NY (US); Natalia Razinkov, Or-Aqiva (IL); Shlomit Schachor Ifergan, Yokneam Eilit (IL); Biplav Srivastava, (US)

(73) Assignee: International Business Machines Corporation, Armonk, NY (US)

(21) Appl. No.: 12/957,438

(22) Filed: Dec. 1, 2010

(51) Int. Cl. G06Q 10/00

(52) U.S. Cl. 705/348

(57) ABSTRACT

A method of operationalizing service methodologies useable for a computerized environment is provided. The method includes the following stages: capturing a method to yield a workflow, work products and template structure; extracting structure and relations from at least one of: the templates, actual work products, workflow, and human experts; modeling the captured structure to yield a method model; augmenting the method-model using the extracted structure and relations, to yield an augmented method-model, such that the augmented method-model provides sufficient data for automatically generating a software application implementing a runtime environment that supports the method.

### BACKGROUND

1. Technical Field

The present invention relates to method model augmentation and more particularly, to generating a structured method model usable for creating a computerized environment for consultants employing the method.

2. Discussion of the Related Art

Today's modern enterprises face an ongoing challenge in content management as the amount of documents produced by consultants (and other users) in these organizations increases exponentially. The current practice for building an environment where consultants create content (work products) that ends up as projects deliverables during project life-cycle involves a labor-intensive error-prone manual derivation of a model from the method, adding complementary information, such as data structure, user interface, connectivity data and the like, and then developing the consultant workbench.

The aforementioned methodology suffers from the following drawbacks: (i) there is no tight integration of the method with the consultant environment; (ii) the complementary information is not incorporated in the method, and thus cannot be edited by the method developer; and finally, (iii) changes in the method are not directly reflected in the consultant environment, so complicated manual tailoring of the consultant workbench is required.

### BRIEF SUMMARY

One aspect of the invention provides a method of operationalizing service methodologies useable for a computerized environment. The method includes the following stages: capturing a method to yield a workflow structure and templates; extracting structure and relations from at least one of: the templates, actual work products, and human experts; modeling the captured workflow structure to yield a method model; and augmenting the method-model using the extracted structure and relations, to yield an augmented method-model, such that the augmented method-model provides sufficient data for automatically generating a software application implementing a runtime environment that supports method.

Other aspects of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an environment of a system according to some embodiments of the invention;

FIG. 2 is a high level schematic block diagram illustrating the system according to some embodiments of the invention;

FIG. 3 is a high level schematic block diagram illustrating an aspect according to some embodiments of the invention;

FIG. 4 is a high level flowchart illustrating a method according to some embodiments of the invention;

FIG. 5 shows an exemplary GUI illustrating an aspect according to some embodiments of the invention; and

FIG. 6 shows another exemplary GUI illustrating yet another aspect according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “artifact” or “work product” as used herein in this application refers to tangible asset (such as document, code, model and the like) consumed, produced, or modified by tasks. They may serve as a basis for defining reusable assets.

The term “deliverable” as used herein in this application refers to a work product that aggregates other work products and used to pre-define typical or recommended content in the form of work products that would be packaged for delivery. The packaging of the deliverable in a process or project could be a modification of this recommendation. Deliverables are used to represent an output from a process that has value, material or otherwise, to a client, customer, or other stakeholder. Method content maintains preconfigured potential deliverables.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

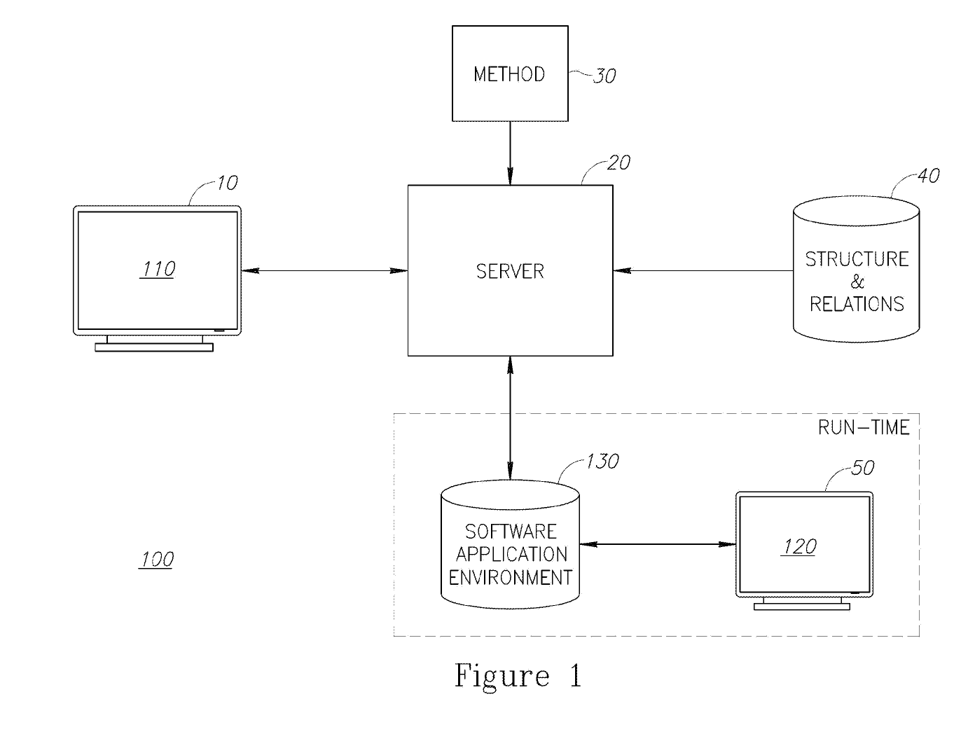

FIG. 1 is a high level schematic block diagram illustrating an exemplary environment of a system 100 according to some embodiments of the invention. System 100 may include a server 20 connected to a terminal 10 over a communication network. Server 20 may be further in operative association with a method 30 and with a plurality of sources containing structure and relations 40 that are associated with method 30.

Method 30 is a sequence of steps over a specified workflow representing a structured expression of how a specific task has to be carried out by a user in an organization. Method 30 is basically a list of operations and milestones associated with work products and finally the deliverables for the clients when the task is completed. A graphical user interface (GUI) 110 may be further provided over terminal 10 and further in communication with server 20. GUI 110 is associated with the developing environment of server 20. Additionally, in a run time environment, a software application environment 130 is further in operative association with server 20. A specified GUI 120 may be further provided over terminal 50 which is operatively associated with software application environment 130.

In operation, server 20 and GUI 110 provide a developing environment enabling a user to capture method 30 and augment it with structure and relations 40 obtained from various sources. An augmented method model is then being used to generate software application environment 130 which is a run time environment that is configured to support the generating and management of work products according to the workflow defined by method 30.

Advantageously, the augmentation of the bare method with structure and relations (both inter relations and intra relations) associated with the workflow, provides sufficient data to the method model such that generation of a computer code for software application environment 130.

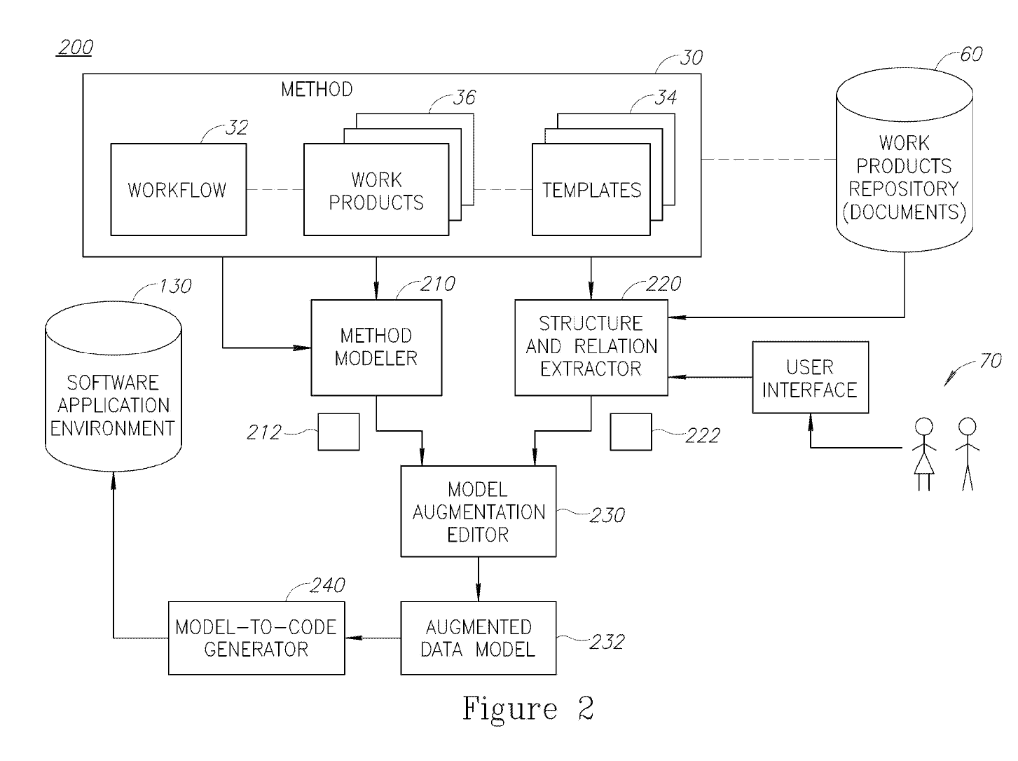

FIG. 2 is a high level schematic block diagram illustrating in more details the system according to some embodiments of the invention. System 200 may include a method modeler 210, a structure and relation extractor 220, and a model augmentation editor 230. Additionally, system 200 may further include a model-to-code generator 240 which may be associated with a software application environment 130, a work products repository 60 associated with structure and relation extractor 220 that is further associated with a user interface. Both method modeler 210 and structure and relation extractor 220 are associated with a method 30 that includes workflow 32 that defines the flow of performing a task in a specified organization. Method 30 further includes work products 36 as well as templates 34 of documents and other work products that are associated with workflow 32 and are generated during the lifecycle of method 30.

In operation, method modeler 210 is used to model workflow 32 and work products 36 captured from method 30, to yield a method model 212. Method model 212 may be in a form of any modeling language that defines flow. Independently, structure and relation extractor 220 is used to extract structure and relations 222 from a plurality of sources. These sources may be, for example: templates 34 captured from method 30, but also from work products repository 60 which is a repository of actual documents (and other work products) that have already been generated using the run time environment of the organization. Finally, further structure and relation may be extracted directly from expert users 70 via a specified user interface.

Once the method model 212 and the corresponding structure and relations 222 have been gathered, model augmentation editor 230 may be used by the users, in an interactive process, to augment the method-model 212 using the extracted structure and relations 222. The augmentation yields an augmented date model 232 characterized in that it provides sufficient data for automatically generating a software application implementing a runtime environment that supports method 30 its work products a complying to the structure and relations associated therewith.

Consistent with one embodiment of the invention system 200 may further include a model-to-code generator 240 that automatically generates the software application environment 130 implementing method 30, based on augmented method-model 230. These model-to-code generators are known in the art and are easily applied to augmented data model 232 due to the comprehensive nature of augmented data model 232 that includes flow, structure, and relations that are sufficient to model the required run time environment implementing a life cycle associated with method 30.

In the run time environment, software application environment 130 supports the full lifecycle of generating and managing the work products for a given method or task. Software application environment 130 may further allow partial project management such as some tasks from method 30, as well as “dashboarding” (obtaining status of work products over the workflow). Additionally, software application environment 130 may provide generic services enablement and management for any complex work products in the generated environment.

In the developing environment, model augmentation editor 230 allows to specify additional methodology content for work products structure which in turn allows to effectively create (auto-generate) software application environment 130. For example, sections of work products may be associates with specific stages or steps along workflow 32. Additionally, specified roles of users of the organization may be defined in regards to which sections on what work products may be changed in which stages along the workflow. In addition, specific work products can be associated with specified tools or which capabilities are used with which tools. Further, information regarding how to generate a deliverable from a specified work product can also be added during the augmentation. Basically, the data regarding the format supplied/required by the client is used to generate a deliverable out of a work product.

All of the aforementioned definitions and contents that are added using model augmentation editor 230 are absent from the bare model 212 captured from method 30 and provide the sufficient information that is necessary to later generate a working run time environment which eliminates the need to employ a software developer in the method-to-environment cycle.

Consistent with one embodiment of the invention model augmentation editor 230 may be configured to enable a user to annotate sections of the augmented method-model such that the annotated sections may be easily searched thus enhancing reusability of these sections, and in particular work product templates, in future projects.

Consistent with one embodiment of the invention, the modules operate over a plurality of distinct related specified methods to yield a family of related augmented models useable for generating a plurality of software applications implementing respective methods.

Consistent with one embodiment of the invention, document structure relates to data structure or data flow of at least one of: forms, tables, and graphical user interface (GUI) elements.

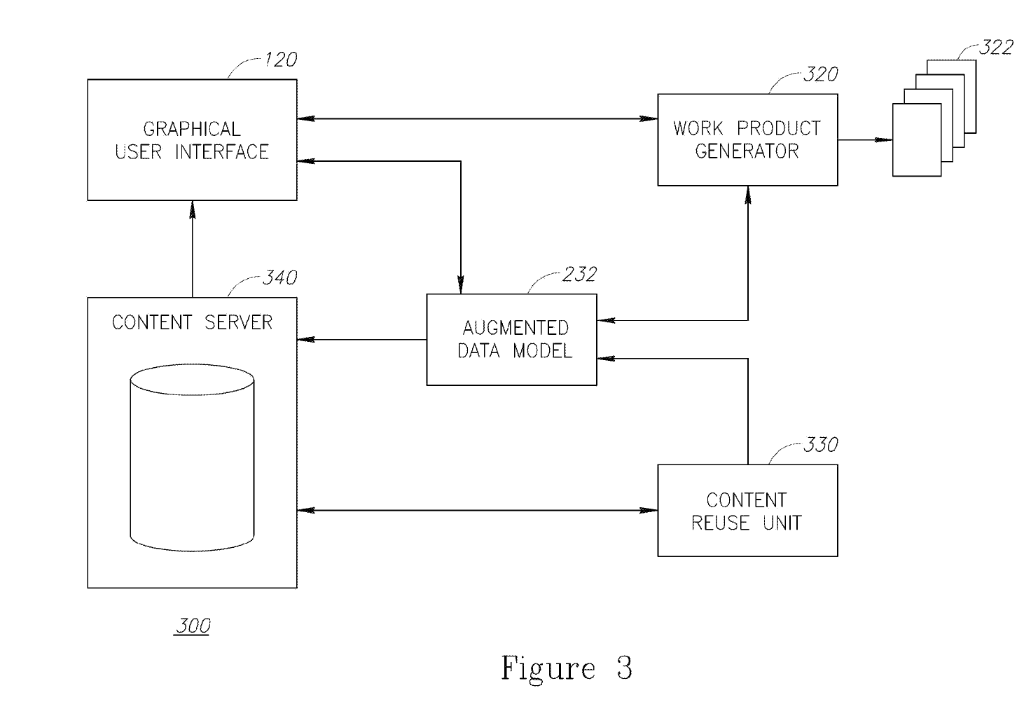

FIG. 3 is a high level schematic block diagram illustrating run time aspects according to some embodiments of the invention. In a run time scheme 300, augmented data model 232 is in operative association with work product generator 320, content server 340, content reuse unit 330, and graphical user interface (GUI) 120.

During run time, users may use work product generator 320 through GUI 120 to generate actual work products 322 that comply with augmented data model 232 in terms of flow, structure, and relations, and based upon the content of the organization obtained from content server 340. Content reuse unit 330 may be used whenever some portions of the data model specification are identified as templates or tagged as reusable by any of the users during either developing time or run time, for future use. This is done by searching contexts associated with required work products as applied to content server 340 in view of augmented data model 232.

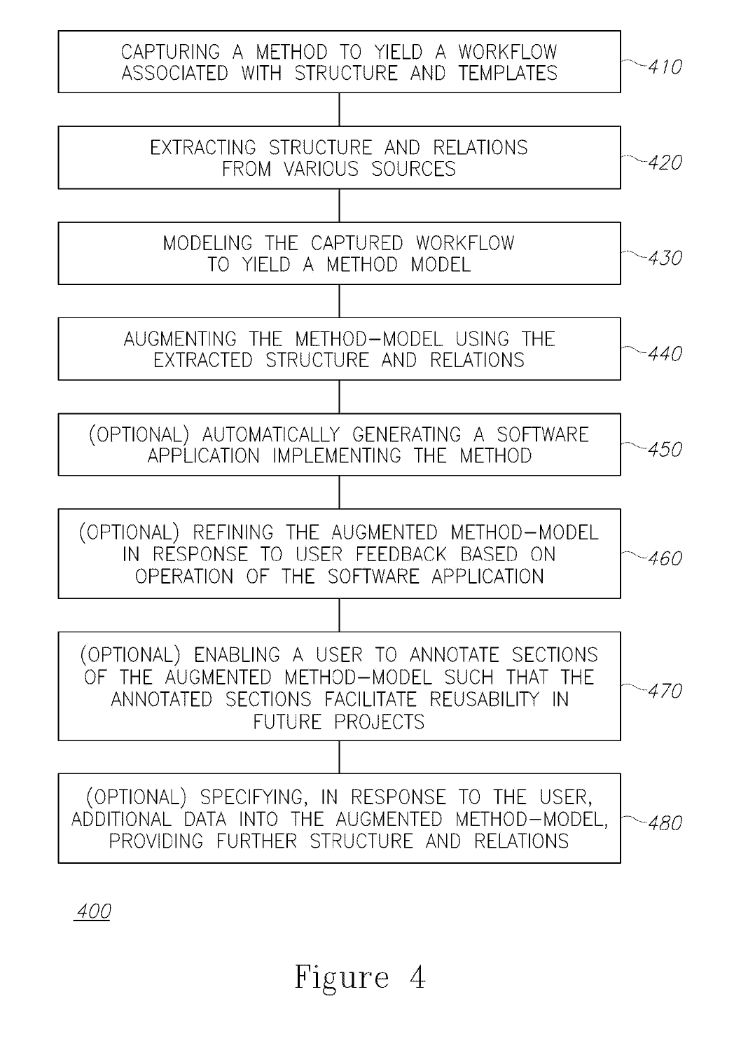

FIG. 4 is a high level flowchart illustrating a method 400 according to some embodiments of the invention. Although method 400 is not necessarily implemented according to the aforementioned architecture of system 200, the following stages of method 400 are described herein in conjunction with the components of system 200. Method 400 starts with capturing 410 a method 30, to yield a workflow 32 and templates 34. This stage may be implemented over a GUI 110 by a user selecting interactively the required content. Method 400 proceeds to extracting 420 structure and relations 222 from several sources such as the captured templates 34, actual work products being documents that are already in use in the runtime environment and also, via a user interface, from human experts 70 who explicitly provide data pertaining to structure and relations. Method 400 then goes on to modeling 430 the captured workflow 32, possibly by method modeler 210, to yield a method model 212. Method 400 then goes on to augmenting 440 the method-model 212 using the extracted structure and relations 222, to yield an augmented data model 232. The augmented data model 232 is being augmented such that it provides sufficient information, derived by the added structure and relations, for automatically generating a software application implementing a runtime environment that supports method 30.

Consistent with one embodiment of the invention, method 400 may further include an optional stage of automatically generating 450 the software application implementing the method, based on the augmented method-model.

Consistent with one embodiment of the invention, method 400 may further include an optional stage of refining 460 the augmented method-model in response to user feedback based on operation of the software application.

Consistent with one embodiment of the invention, method 400 may further include an optional stage of enabling 470 a user to annotate sections of the augmented method-model such that the annotated sections facilitate reusability in future projects.

Consistent with one embodiment of the invention, method 400 may further include an optional stage of specifying 480, in response to user selection or determining, additional data into the augmented method-model. The additional data provides further structure and relations to the augmented method-model. The additional data includes at least one of: associating sections of work products with corresponding steps of the method, determining roles of users associates with authorization relating to operations in specified work products, associating work products with specified tools in the run time environment, and associating specified work product with corresponding formats required to generate a specified deliverable.

In order to implement method 400, a computer (not shown) may receive instructions and data from a read-only memory or a random access memory or both. At least one of aforementioned stages may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

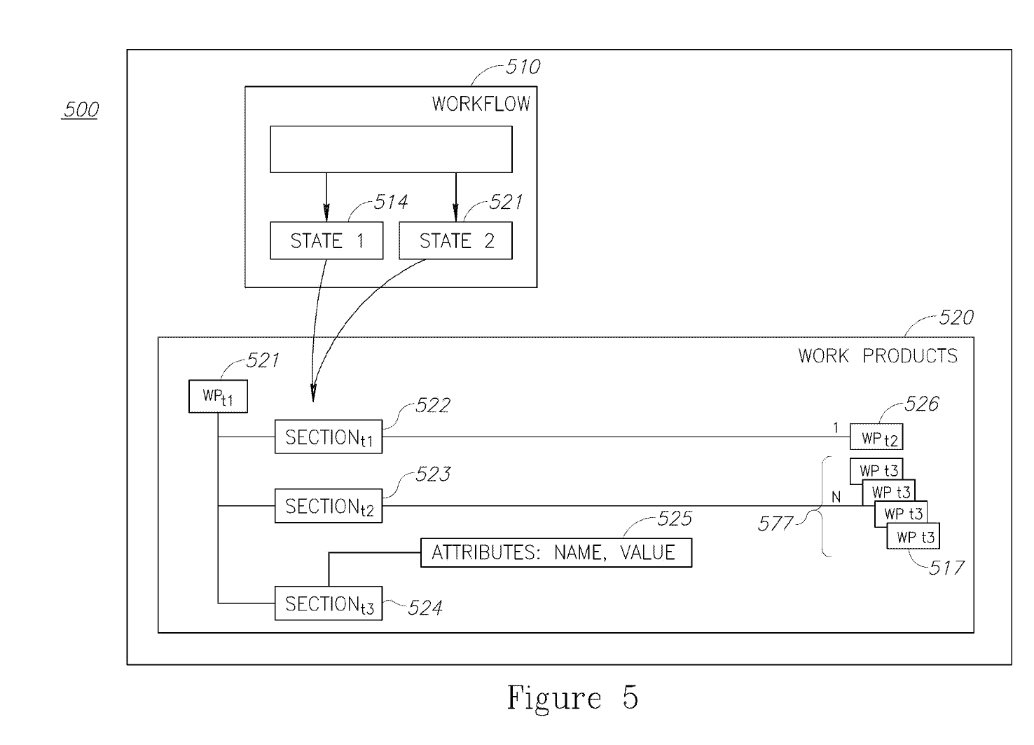

FIG. 5 shows an exemplary GUI display of model augmentation editor 230 illustrating aspects according to some embodiments of the invention. Display 500 presents the captured workflow 510 of an arbitrary method and a corresponding map of work products 520 associated with the captured method. Workflow 510 is shown with its states: State 1 514 and State 2 521. Work products 520 are shown as work product types such as work product type WPₜ₁ 521 and its sections 522, 523, and 524.

GUI display 500 enables a user to define sections 522-524 of work product type WPₜ₁ 521 during the augmentation by adding structure and relations to WPₜ₁ 521. For example, a section, such as Sectionₜ₃ 524 can be defined as having several attributes presented as name and value pairs 525. Another section, such as Sectionₜ₁ 522 can be defined by the user as being linked to a single work product such as WPₜ₂ 524 (of a certain type). Yet another section, such as Sectionₜ₂ 523 may be associated with several work products 577 (of a common or different type). Additionally, GUI display 500 enables the user to graphically associate relations between workflow states 514 and 521 and work product sections 522-524 or work product attributes 525. These relations define the activeness of the sections 522-524 or the attributes 525 with respect to the workflow states 514 or 521.

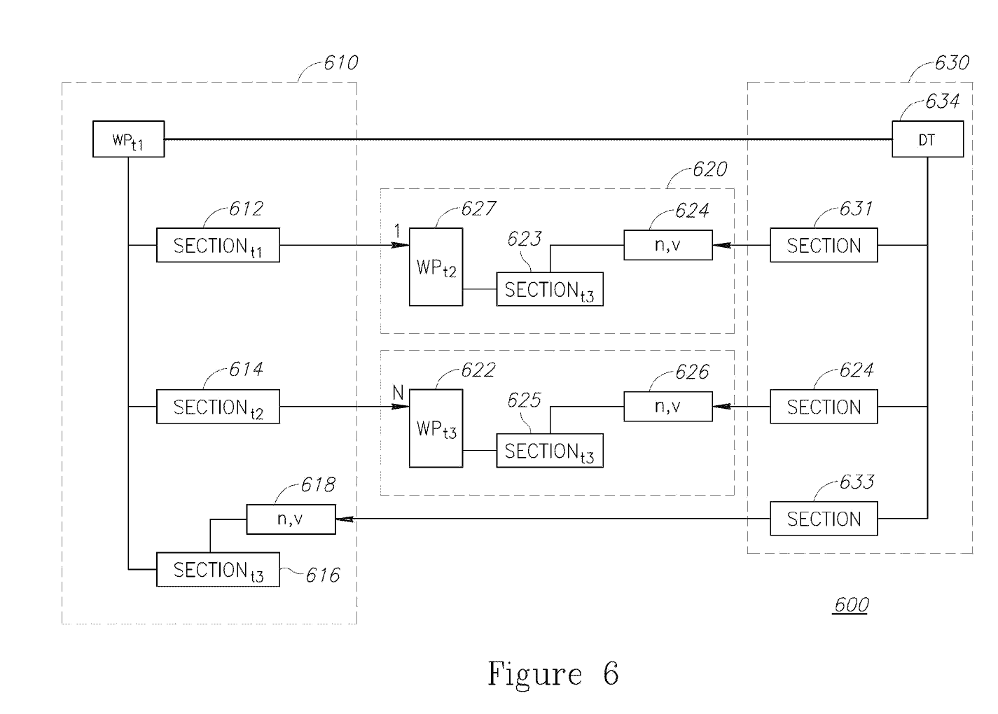

FIG. 6 shows another GUI display in accordance with another aspect of the invention. GUI Display 600 shows an exemplary representation of the relationship between the structure of document type 634 of a work product type WPₜ₁ and the structure 610 of work product type WPₜ₁ᵢ itself. Specifically, document type 634, being a deliverable packed in a form and structure in accordance with specified requirements, is shown in a document type structure 630 with its structural information of sections 631, 624, and 633 that have been derived, for example, by the structure and relation extractor 220. In addition, the association (or mapping) that is required to be carried out in order to convert work product type WPₜ₁ into document type 634 is shown in 620 which contains more structural and relative information showing further relations to other work products such as 622 and 627, more sections such as 623 and 625 and more attributes such as 624 and 626.

By the aforementioned layout of GUI display 600, the user can define association 620 between a single document type 634 and a single work product type WPₜ₁ and define the relations between the document type sections 631, 624, and 633 and the work product sections 612, 614, and 616 or attributes 618 retrieved earlier, for example by GUI display 500.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
capturing a method to yield a workflow, work products and templates;
extracting structure and relations from at least one of: the templates, actual work products, workflow, and human experts;
modeling the captured structure and relations to yield a method model; and
augmenting the method-model using the extracted structure and relations, to yield an augmented method-model, such that the augmented method-model provides sufficient data for automatically generating a software application implementing a runtime environment that supports the method,
wherein at least one of: the capturing, the extracting, the modeling, and the augmenting is executed by at least one processor.

2. The method according to claim 1, further comprising automatically generating the software application implementing the method, based on the augmented method-model.

3. The method according to claim 2, further comprising refining the augmented method-model in response to user feedback based on operation of the software application.

4. The method according to claim 1, further comprising enabling a user to annotate sections of the augmented method-model such that the annotated sections facilitate reusability in future projects.

5. The method according to claim 1, further comprising specifying, in response to user selection or determining, additional data into the augmented method-model, such that the additional data provides further structure and relations to the augmented method-model, wherein the additional data comprises at least one of: associating sections of work products with corresponding steps of the method, determining roles of users associated with authorization relating to operations in specified work products, associating work products with specified tools in the run time environment, and associating specified work product with corresponding formats required to generate a specified deliverable.

6. The method according to claim 1, wherein the capturing and the augmenting are performed over a plurality of distinct related specified methods to yield a family of related augmented models useable for generating a plurality of software applications implementing respective methods.

7. The method according to claim 1, wherein the structure and relations pertain to at least one of: graphical user interface (GUI) elements, and work products.

8. A system comprising:
a method modeler;
a structure and relation extractor; and
a model augmentation editor,
wherein the method modeler is configured to model workflow, work products and templates structure captured from a method, to yield a method model,
wherein the structure and relation extractor is configured to extracting structure and relations from a plurality of sources,
wherein the model augmentation editor is configured to augment the method-model using the extracted structure and relations, to yield an augmented method-model, such that the augmented method-model provides sufficient data for automatically generating a software application implementing a runtime environment that supports the method, and
wherein the method modeler, the structure and relation extractor, and the model augmentation editor are carried out by at least one processor.

9. The system according to claim 8, further comprising a model to code module configured to automatically generate the software application implementing the method, based on the augmented method-model.

10. The system according to claim 9, further comprising a refining module configured to tune the augmented method-model in response to user feedback based on operation of the software application.

11. The system according to claim 8, further comprising an annotation module configured to enable a user to annotate sections of the augmented method-model such that the annotated sections facilitate reusability in future projects.

12. The system according to claim 8, wherein the model augmentation editor is further configured to specify, in response to user selection or determining, additional data into the augmented method-model, additional data provides further structure and relations to the augmented method-model, wherein the additional data comprises at least one of: associating sections of work products with corresponding workflow state of the method, determining roles of users associated with authorization relating to operations in specified work products, associating work products with specified tools in the run time environment, and associating specified work product with corresponding formats required to generate a specified deliverable.

13. The system according to claim 8, wherein the modules operate over a plurality of distinct related specified methods to yield a family of related augmented models useable for generating a plurality of software applications implementing respective methods.

14. The system according to claim 8, wherein the structure and relations pertains to at least one of: graphical user interface (GUI) elements, and work products.

15. A computer program product, the computer program product comprising:
a computer readable storage medium having computer readable program embodied therewith, the computer readable program comprising:
computer readable program configured to model workflow, work products and template structure captured from a method, to yield a method model;
computer readable program configured to extracting structure and relations from a plurality of sources; and
computer readable program configured to augment the method-model using the extracted structure and relations, to yield an augmented method-model, such that the augmented method-model provides sufficient data for automatically generating a software application implementing a runtime environment that supports the method.

16. The computer program product to claim 15, further comprising computer readable program configured to automatically generate the software application implementing the method, based on the augmented method-model.

17. The computer program product according to claim 15, further comprising computer readable program configured to refine the augmented method-model in response to user feedback based on operation of the software application.

18. The computer program product according to claim 15, further comprising computer readable program configured to enable a user to annotate sections of the augmented method-model such that the annotated sections facilitate reusability in future projects.

19. The computer program product according to claim 15, further comprising computer readable program configured to specify, in response to user selection or determining, additional data into the augmented method-model, such that the additional data provides further structure and relations to the augmented method-model, wherein the additional data comprises at least one of: associating sections of work products with corresponding workflow state of the method, determining roles of users associated with authorization relating to operations in specified work products, associating work products with specified tools in the run time environment, and associating specified work product with corresponding formats required to generate a specified deliverable.

20. The computer program product according to claim 15, wherein the structure and relations pertains to at least one of: graphical user interface (GUI) elements, and work products.
